(19) United States
(12) Patent Application Publication
(10) Pub. No.: US 2021/0038022 A1
(43) Pub. Date: Feb. 11, 2021

(54) HEAT SOURCE DEVICE RETROFIT FOR COOKING GRILL

(71) Applicant: Oliver Products, LLC, Fremont, OH (US)

(72) Inventor: James R. Gippert, Fremont, OH (US)

(21) Appl. No.: 16/985,743

(22) Filed: Aug. 5, 2020

Related U.S. Application Data
(60) Provisional application No. 62/883,392, filed on Aug. 6, 2019.

(51) Int. Cl. A47J 37/07; A23B 4/052

(52) U.S. Cl. CPC A47J 37/0704; A23V 2002/00; A23B 4/052

(57) ABSTRACT

A heat source device is provided for supplying indirect heat to a cooking grill such as a charcoal grill. The heat source device includes a heat chamber body to contain a heat source remotely spaced from the grill, an access door to access the heat source, and a mounting adapter to couple the heat source device to the grill. The heat source device may be configured to couple to an existing charcoal grill, as in a retrofit arrangement in which the mounting adapter couples to an ash catcher mount of the grill. The heat source device allows a user to feed or maintain a fuel source in the heat chamber to regulate the temperature in the grill without the need to open the grill, remove the food, or remove or open the cooking surface. If the heat source is maintained, the grill may operate indefinitely.

### CROSS REFERENCE TO RELATED APPLICATION

The present application claims the benefit of U.S. provisional application Ser. No. 62/883,392, filed Aug. 6, 2019, which is hereby incorporated herein by reference in its entirety.

### FIELD OF THE INVENTION

The present invention is directed to grills for cooking, and more particularly, to an indirect heat source for charcoal grills.

### BACKGROUND OF THE INVENTION

Charcoal cooking grills typically include a lower portion or chamber and an upper portion or lid. The upper portion includes vent openings and a closure mechanism associated with the vent openings to adjust the size of the openings to control temperature and fuel combustion. The lower portion or chamber includes a fuel grate located near the bottom of the chamber to hold the charcoal or other fuel used for cooking. A cooking grate is located near the top of the chamber and above the fuel grate to support the food being cooked. Vent openings are also provided on the bottom of the chamber to provide combustion air for the cooking fuel and to provide a means to clean-out ashes and other debris that accumulates during the cooking process. Charcoal grills are configured to grill or cook food with direct heat from a heat source that is located proximate the cooking surface, or may be set up for indirect heat by placing charcoal beneath one area of the cooking surface and placing food along a different area of the cooking surface.

Refilling or feeding the fuel source for a charcoal grill typically includes opening the lid of the grill, removing the food from the cooking surface, removing the grilling surface, and then adding fuel in a lower portion of the cooking chamber. The grilling surface is replaced and then the food is replaced to continue cooking on the grill. Some conventional cooking grills include pivoting portions of the grill grate to access and maintain the fuel source without removing the entire grill grate cooking surface. The pivoting portion must remain free of food to allow that portion to pivot to access the fuel source, thereby limiting the available cooking surface in the grill. Opening the grill during low-temperature cooking substantially affects the cooking time and the cooking quality of the grill due to interruptions in the heated environment in the cooking chamber with increasing cooking time in order to re-heat the cooking chamber to a proper cooking temperature.

### SUMMARY OF THE INVENTION

The present invention provides a readily feedable indirect heat source device or firebox for a charcoal grill, which device can be fed with additional fuel (such as charcoal) without opening a lid above a cooking surface. The device has an access door remotely spaced from a cooking chamber of the grill to feed, manage, or smother a heat source for the grill without manipulating the cooking surface of the grill. The feedable heat source provides consistent indirect heat indefinitely to the grill without interrupting the interior of the grill, as long as the heat source is maintained. The user does not need to open the grill, remove the food being cooked, remove the grill grate or cooking surface, or reload charcoal or wood directly into the grill.

In one form of the present invention, a heat source device is provided for indirectly supplying heat to a cooking grill, the heat source device including a heat chamber to confine a heat source remotely spaced from a cooking chamber of the grill, an access door configured to provide access the fuel source inside the heat chamber, and a mounting adapter configured to mount the heat source device to the grill. The heat chamber includes a heat transfer aperture or opening in an upper region of the heat chamber that is configured to allow heat and smoke to rise upward through the heat transfer aperture and through another aperture in a lower portion of the cooking chamber portion of the grill. The heat transfer aperture in the upper region of the heat chamber may be defined by an upwardly-facing hole or slot defined by a sidewall of the heat chamber. The aperture in the lower portion of the cooking chamber may be defined by a hole or slot configured to allow ashes to fall from the cooking chamber to an ash catcher device.

For grill retrofit applications, at least a portion of the ash catcher is removed to accommodate attachment of the heat source device to the remaining portion of the ash catcher and to allow heat and smoke to pass from the heat chamber to the cooking chamber. Flashings or covers may be attached to exterior portions of the ash catcher or the heat source device to a seal originally manufactured perforated portions of the ash catcher. The cooking grill can be operated as a conventional cooking grill if the fuel source is disposed in the cooking chamber, or as a smoker or low temperature cooker if the fuel source is disposed in the heat chamber. When the heat source device is installed on the cooking grill and when the cooking grill is operated as a conventional cooking grill, the heat source device can be utilized as an ash catcher wherein ashes from the heat source disposed in the cooking chamber fall through openings in the grill bottom and into the heat source device.

In another aspect, the heat chamber includes a flue damper disposed in a wall of the heat chamber. The flue damper allows a user to manually adjust or regulate the amount of air flow into the heat chamber to control the consumption rate of the fuel in the heat chamber. Optionally, the heat source device includes a plurality of flue dampers to provide additional airflow adjustability for the heat source device. The damper may be a conventional rotating flue damper such as typically found on conventional charcoal cooking grills or a slideable panel or cover flue damper. In one aspect, a damper cover is slideably coupled to a side wall of the heat source and the damper cover is slideable to cover or uncover a plurality of holes disposed through a side wall of the heat chamber. In another aspect, a damper cover is rotationally coupled to a side wall of the heat source device and the damper cover includes a plurality of holes circumferentially spaced on the cover. The damper holes correspond in size and arrangement to a plurality of holes disposed through a side wall of the heat chamber. The damper cover is rotationally disposed at a location on the side wall such that the center of the damper cover is positioned adjacent to a center of the holes disposed in the side wall.

In one aspect, the damper cover is operable to slide along a path defined by tracks that secure the damper cover and to the side wall. The damper cover is operate to slide to a fully open position such that the holes of the heat chamber are fully uncovered to allow a maximum flow of air through the flue damper. The damper cover is operable to slide to a fully closed position such that a portion of material of the damper cover is positioned over each of the holes in the side wall so substantially all of the flow of air into the heat source device is blocked. The damper cover is operable to slide to a plurality of intermediate positions between the fully open and the fully closed orientations to provide an adjustable flow of air into the heat source device to allow a user to adjust or maintain a desired temperature inside the heat source device and the grill.

In another form of the present invention, a cooking grill is provided for low temperature cooking and smoking of food, the cooking grill includes a cooking chamber configured to support a food item to be cooked and to contain heat or smoke proximate the food item to facilitate cooking and smoking of the food item. The cooking grill includes a smoke and heat source device releasably coupled to a lower portion of the cooking chamber. The smoke and heat source device includes a heat chamber to contain the fuel and smoke and/or heat source and an access door to access the heat source without opening the cooking chamber and without removing the smoke and heat source device from the grill.

In one aspect, the cooking grill includes a removable liquid container pan, such as a water pan. The water pan may be removably disposed in the heat chamber to increase the relative moisture inside the cooking chamber. The water pan provides an additional barrier between the heat source and the food, thereby providing indirect heat to further slow the cooking rate of the food. The additional moisture from the water pan may decrease the amount of surface dehydration experienced by the food being cooked, thereby maintaining a higher moisture content and better flavor of the finished food product.

In another aspect, the heat source device includes a removable and adjustable support rack, such as for containing wood chips to be heated by the fuel source to produce smoke. As the wood chips are heated they begin to smolder and put off smoke. The smoke is directed from the heat chamber into the cooking chamber and the smoke adds flavor to the food item. The support rack may be defined by a slideable drawer that is operable to allow a user to maintain the wood chips without opening the heat chamber access door.

Therefore, the feedable heat source device of the present invention can indefinitely supply heat and/or smoke to a cooking chamber of a grill without the need to open the grill, remove the food and the cooking surface and add fuel to the cooking chamber. The heat source device may be configured to releasably couple to an existing charcoal grill, such as a kettle grill, as a retrofit. The heat source device includes a mounting adapter to secure the device to the grill. The mounting adapter may be configured to couple to a portion of an ash catcher device that is mounted on the grill. The heat source device includes a heat chamber with an access door to allow a user to access and feed or maintain a fuel source disposed in the heat chamber. As long as a user maintains the fuel source, the grill can be operated indefinitely to cook food at low temperatures without interruption. A flue damper is provided to regulate air flow into the heat chamber to allow a user to adjust and regulate the consumption rate of the fuel inside the heat chamber. The heat source device may include additional features including a water pan to dissipate heat and provide additional moisture to the cooking chamber, and a wood chip support rack to contain wood chips to be heated to produce smoke that can transfer into the cooking chamber to add flavor to the food.

These and other objects, advantages, purposes, and features of the present invention will become more apparent upon review of the following specification in conjunction with the drawings.

### BRIEF DESCRIPTION OF THE DRAWINGS

FIG. 1 is a perspective view of a charcoal grill with feedable indirect heat source device in accordance with the present invention, shown mounted to a charcoal grill;

FIG. 2 is an exploded perspective view of the heat source device and the grill of FIG. 1;

FIG. 2A is an enlarged view of the region designated 2A in FIG. 2;

FIG. 3 is a front elevation view of the heat source device of FIG. 1;

FIG. 4 is a side elevation view of the heat source device of FIG. 1;

FIG. 5 is a sectional view of the heat source device of FIG. 3 taken along line V-V of FIG. 3; and

FIG. 6 is a top view of the heat source device of FIG. 1.

### DESCRIPTION OF THE PREFERRED EMBODIMENTS

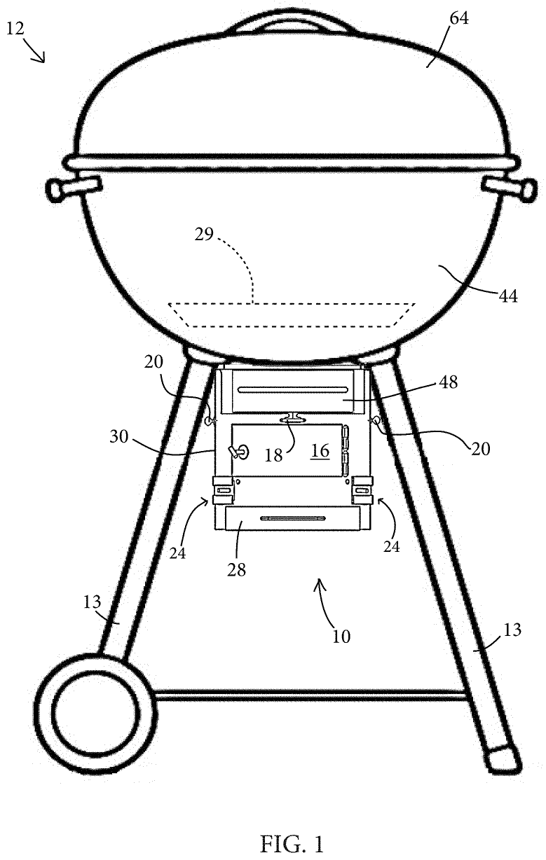

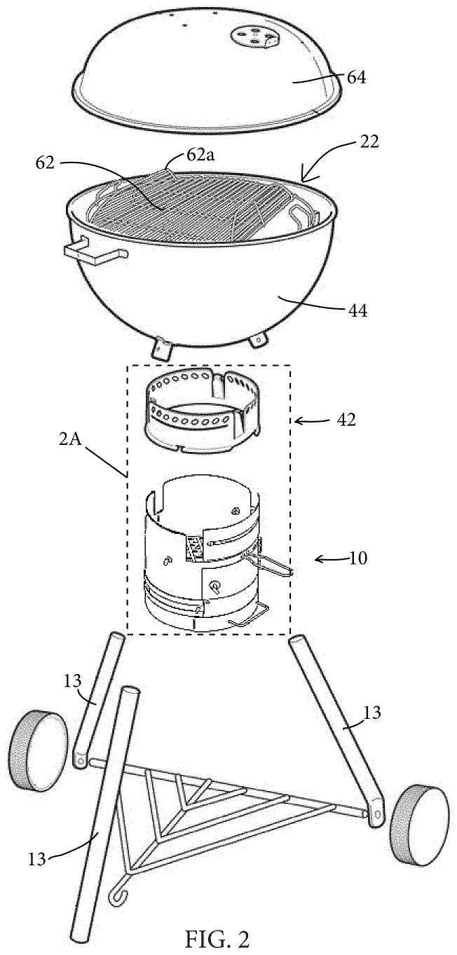

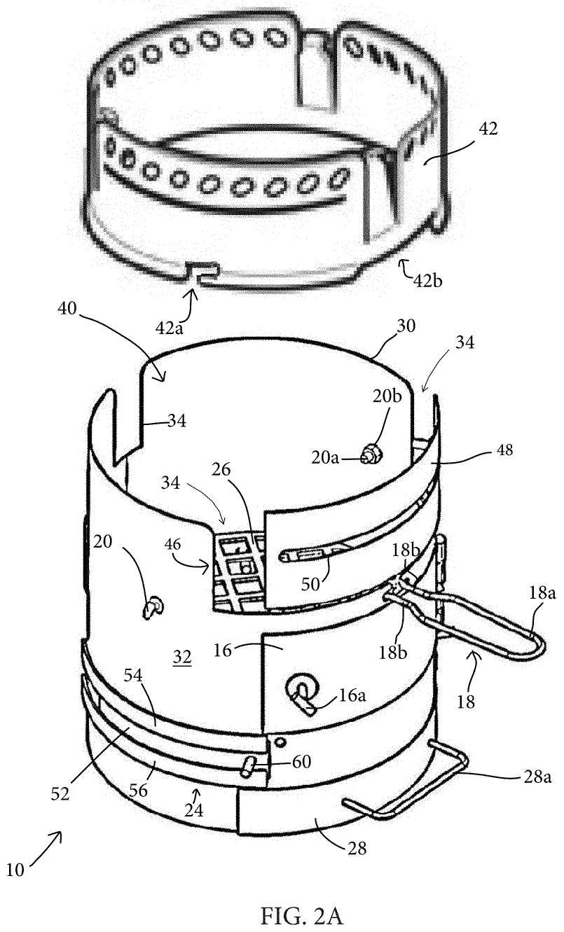

Referring now to the drawings and the illustrative embodiments depicted therein, a feedable indirect heat and/or smoke source device or firebox 10 is provided for supplying heat and/or smoke to a cooking grill 12, such as a charcoal cooking grill. (FIGS. 1-6). The heat source device 10 includes a heat chamber 14 configured to confine a heat source or fuel, such as burning wood or charcoal. The heat source device 10 includes an access door 16 and a grill mounting adapter, such as in the form of a combination of a releasable or latchable handle 18 and mounting tabs or extensions 20, which cooperate to couple the heat source device to a portion of the grill 12 (FIGS. 1-6). The access door 16 allows a user to access the heat chamber 14 to feed or maintain the heat source, such as by adding or removing fuel inside the heat chamber 14. The mounting adapter 18 allows the heat source device 10 to be removably attached to a lower portion of the cooking grill 12 such that heat and smoke transfer from the heat source device 10 to a cooking chamber 22 of the grill 12 (FIGS. 1 and 2). A pair of grill mounting tabs or extensions 20, together with the handle 18, serve to removably secure the heat source device 10 to the grill 12.

The heat source device 10 contains the heat (fuel) source in a location remote from the cooking chamber 22 and allows a user to adjust or maintain the temperature of the grill 12 without opening the cooking chamber 22 and without touching the food or adjusting the cooking surface inside the grill 12. The heat source device 10 directs smoke into the cooking chamber 22 and is operable to maintain substantially consistent temperature inside the cooking chamber 22, and reduces the risk of cooking one portion of the food too quickly. The heat source device 10 is configurable for use with charcoal, wood chips, wood pellets, and the like. Additional features of the heat source device 10 include an adjustable flue vent or damper 24 (FIGS. 1-4), a heat source or fuel support surface or grate 26 (FIGS. 2A, 5 and 6), and an ash catch pan or drawer 28 (FIGS. 1-6). Optionally, a removable liquid container pan 29 is provided for the grill's cooking chamber (FIG. 1), although a smaller version may be placed inside the device 10. The heat source device 10 may be adapted for attachment to an existing grill 12 as an after-market system, or in combination with a pre-manufactured grill with heat source device 10.

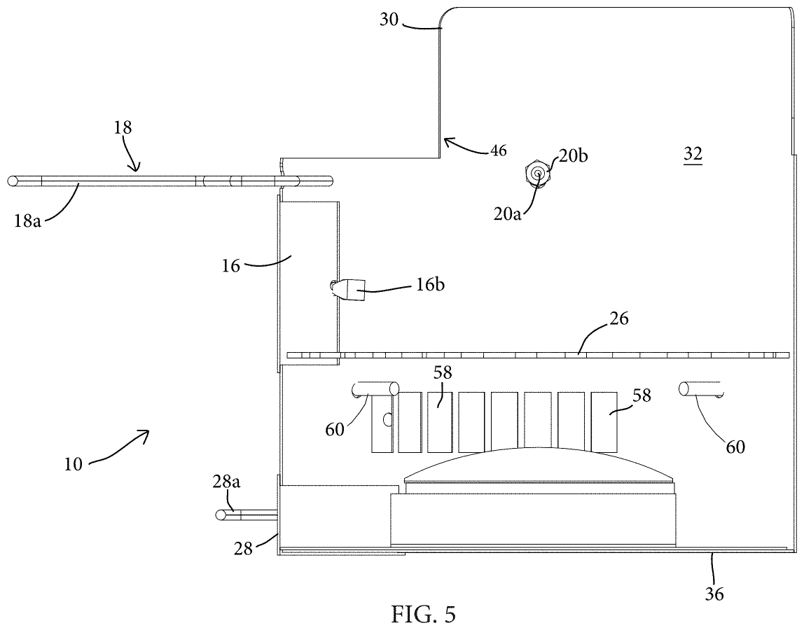

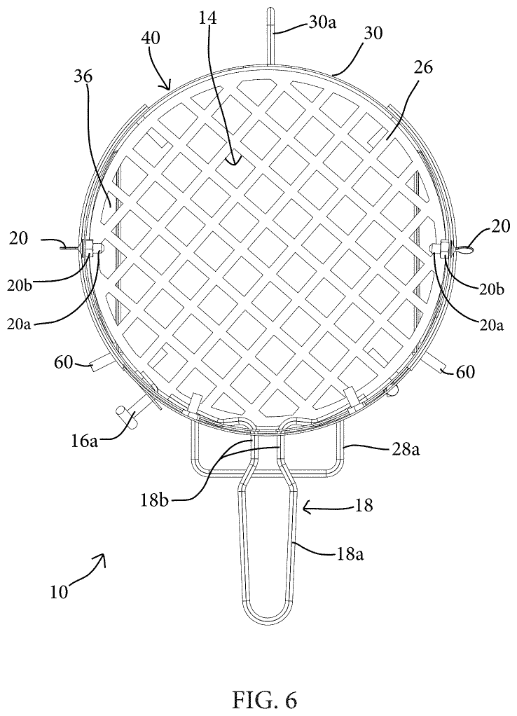

In the illustrated embodiment, the heat source device 10 is configured for retrofitting an existing charcoal grill 12 (FIGS. 1-6). The heat chamber 14 is defined by a cylindrical chamber body 30 having an elongated cylindrical side wall 32 and a bottom 36 (FIGS. 5 and 6). Access door 16 is hingedly attached to a portion of the side wall 32 and is openable and closeable to at least partially seal the chamber body 30 at an access opening 38 defined by a hole through the side wall 32. It will be appreciated that other shapes and volumes may be provided for the heat chamber 14, such as square or rectangular boxes.

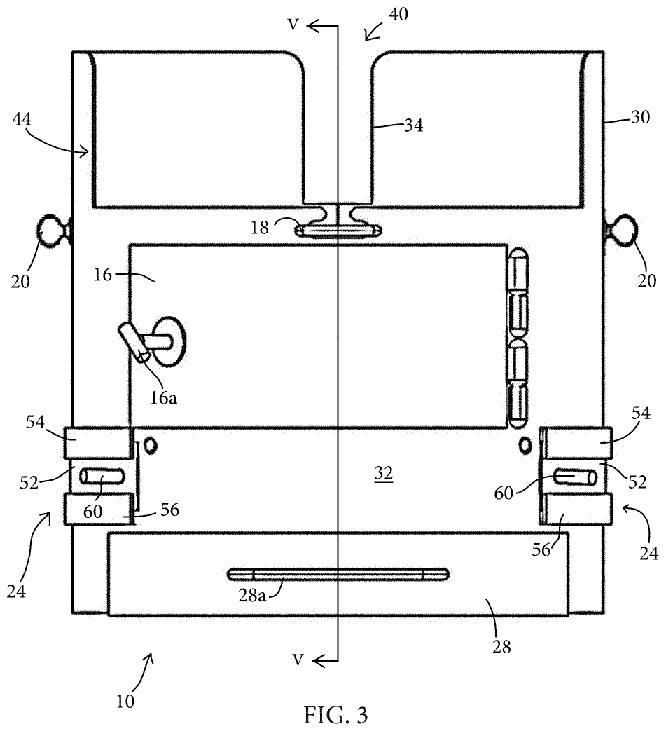

The access opening 38 provides access to the heating chamber 14 to allow a user to add to, remove from, or maintain the heat source along the fuel grate 26 inside the chamber body 30. The fuel grate 26 is normally supported on a plurality of grate support projections 39 (FIG. 5) when in use, though it will be appreciated that in FIG. 5 the fuel grate 26 is shown spaced above the grate support projections 39. The chamber body 30 includes a heat transfer opening or aperture 40 to allow heat and smoke to transfer from the heating chamber 14 into the cooking chamber 22 of the grill 12. In the illustrated embodiment, the heat transfer opening 40 is defined by an upwardly-facing circular hole in the top of the chamber body 30, such as shown in FIGS. 2 and 3. The diameter of the heat transfer opening 40 generally corresponds to the diameter of an opening in the grill 12 that provides an ash disposal port (not shown) along a bottom portion of the cooking chamber 22 of the grill 12. The upper portion of the chamber body 30 is formed with grill leg receiver slots 34 formed in the side wall 32 to receive respective grill legs 13 when the heat source device 10 is installed onto the grill 12. A gripping element, such as a handle 30a, is attached to the chamber body 30 to provide a user a place to easily grip or manipulate the heat source device 10.

The access door 16 includes a securing member, such as a rotatable and latchable handle 16a (FIGS. 1-6). In the illustrated embodiment the handle 16a includes a rotatable rod or bar mounted on the access door 16. The handle 16a extends radially outwardly and inwardly from the access door 16. The portion of the handle 16a on the exterior side of the door 16 is provided for the user to rotate the handle 16a and for the user to manipulate the access door 16. The portion of the handle 16a on the interior side of the door 16 includes a latch tab 16b, which when the handle 16a is rotated to a latching position the tab 16b extends beyond the edge of the side wall 32 that defines one side of the access opening 38 such that the tab would contact the side wall 32 if a user attempted to open the door 16. When the handle 16a is rotated to a non-latching position the tab 16b is substantially inboard of the edge of the door 16 and will not contact the side wall 32 if a user attempts to open the door. It will be appreciated that various types of handles and latches are known which may also be used to provide a handle or securing member for the access door 16.

The lower region of the grill 12 surrounding the ash disposal port supports a mounting sleeve 42 that is part of an original ash collector (not shown) on an exterior portion of the grill body 44. An example of such an ash collector and mounting sleeve is disclosed in expired U.S. Pat. No. 5,036,832, issued to Weber-Stephen Products Co., the disclosure of which is incorporated herein by reference. In the illustrated embodiment, the heat source device 10 mounting adapter includes mounting tabs 20 provided at an upper portion of the heat source device 10 to secure the device 10 to the mounting sleeve 42, and to allow heat and smoke to transfer through the ash disposal port and into the cooking chamber 22. (FIGS. 1-4). In the illustrated embodiment, the mounting tabs 20 have a flattened circular shape, however it will be appreciated that other shapes and sizes of tabs may be used. The mounting tabs 20 are secured to the sidewalls with a mechanical fastener, such as a threaded stud 20a passing through the side wall 32 and a nut 20b threadedly fastened to the threaded stud (best shown in FIGS. 2A and 5).

The mounting adapter of the illustrated embodiment includes a handle 18 that is formed similar to the handle member disclosed in U.S. Pat. No. 5,036,832. The mounting adapter is configured to secure a portion of heat source device 10 to the mounting sleeve 42 that is mounted to the grill body 44 proximate the ash disposal port. In the illustrated embodiment, the handle 18 extends radially outwardly from the side wall 32, such as shown in FIGS. 2A and 4-6. Similar to the handle member in U.S. Pat. No. 5,036,832, the handle 18 includes a hoop portion 18a and a pair of opposed inwardly bent sections 18b, as best shown in FIG. 6. The hoop portion 18a provides a handle for a user to manipulate the heat source device 10. The mounting tabs 20 are mounted through respective openings at opposite sides of the side wall 32, spaced away from the handle 18. The tabs 20 extend radially outwardly from the side wall 32. Mounting tabs 20 and handle 18 can be lifted into respective receiver slots 42a and 42b (typically having an inverted L shape) that are formed along a bottom edge region of the mounting sleeve 42 (FIG. 2A). This allows the heat source device 10 to be lifted into initial engagement of the heat source device 10 with the mounting sleeve 42 so that the handle 18 and mounting tabs 20 are raised into respective slots 42a, 42b in the mounting sleeve, after which a short rotational movement of the handle 18, and thus the device 10, causes the bent sections 18b of the handle 18 and tabs 20 to lock in to their respective slots in the mounting sleeve 42, at which point the heat source device 10 will be fully supported by the mounting sleeve 42 and grill body 44. Dismounting the heat source device 10 can be easily accomplished by twisting (or lifting and twisting) the device 10 and then lowering it to disengage the handle 18 and tabs 20 from their respective slots 42b, 42a. Thus, the device 10 can be mounted and dismounted at the grill 12 in a twist-lock procedure, similar to the manner in which an original ash catcher pan would be attached to and detached from the grill 12 at the mounting sleeve 42. By utilizing the original ash catcher mounting sleeve 42 provided with a grill, the device 10 can be retrofitted to the grill when slow cooking and smoking are desired, and can be readily removed and the original ash catcher pan replaced at the mounting sleeve 42 for normal higher-heat and/or direct-heat grilling techniques.

The body 30 of the heat source device 10 is configured to contain and direct heat and smoke toward the cooking chamber 22, via the heat transfer opening 40 and mounting sleeve 42, as the heat and smoke rise from the heating chamber 14 toward the grill 12. The body 30 is formed from heat-resistant materials and configured to mate to the mounting sleeve 42 to form an at least partially air-tight seal between the grill 12 and the heat source device 10. It should be appreciated that an alternative mounting adapter may utilize a one-piece heat source adapter for coupling the body 30 of the heat source device to either the mounting sleeve 42 or the grill body 44.

Charcoal grills, to which the heat source device 10 may be coupled, often include a damper, an ash rake, or a combination damper and ash rake, such as disclosed in expired U.S. Pat. No. 4,624,239 issued to Yellin, the disclosure of which is incorporated herein by reference. Dampers/ash rakes typically include a handle portion that extends generally horizontally away from a bottom portion of the grill, which enables a user to rotate the damper/ash rake at a generally remote location spaced a distance away from the body of the grill to avoid contacting hot surfaces of the grill. In the illustrated embodiment, a damper adjustment opening or space 46, defined by a cutout in an upper portion of the chamber body 30, provides a space to receive the damper/ash rake handle and allow for the damper handle to be adjusted from side to side without contacting the chamber body 30 (FIGS. 2A-5).

A flashing or cover 48 is provided with the heat source device 10 to at least partially seal the damper adjustment opening 46 to further direct heat from the heating chamber 14 to the cooking chamber 22 (FIGS. 1-2A). The flashing 48 also functions to shield heat from radiating from the grill 12 and heat source device 10 toward the damper handle portion. In the illustrated embodiment, the flashing 48 includes a damper handle adjustment slot 50 disposed horizontally through a center portion of the flashing 48 (FIG. 2A). The slot 50 is configured to receive the damper handle when the flashing 48 is installed onto the heat source device 10 and over the damper adjustment opening 46. The flashing 48 may be removably coupled to the body 30 of the device 10. Optionally, the flashing 48 may be hingedly attached to an exterior portion of the side wall 32. The flashing 48 also provides a seal over originally manufactured perforated portions (not shown) of the mounting sleeve 42 that are exposed at the damper adjustment opening 46 when the heat source device 10 is fully mounted to the mounting sleeve 42. The flashing 48 provides an additional seal between the heat source device 10 and the grill 12 to direct heat and smoke into the cooking chamber 22.

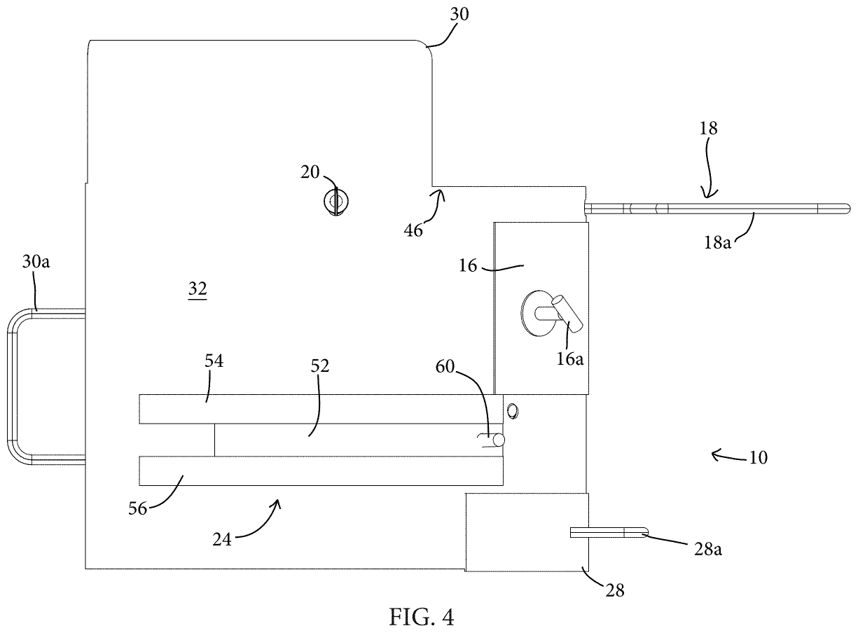

The heat source device's flue damper 24 is disposed at a portion of the side wall 32 and below the fuel grate 26 (FIGS. 1-4). The flue damper 24 provides a manually adjustable air control to allow a user to regulate the amount of air flow into the heat chamber 14 of the heat source device 10, to control the rate of consumption of the fuel in the heat chamber 14 and temperature in the cooking chamber 22. In the illustrated embodiment, the heat source device 10 includes two flue dampers 24 spaced on opposed sides of the chamber body 30 (FIGS. 1 and 4). However, it will be appreciated that a single flue damper may provide adequate airflow adjustability, or three or more flue dampers may be provided to provide additional airflow adjustability for the heat source device 10.

In the illustrated embodiment of FIGS. 1-4, flue damper 24 includes a damper cover 52 that is moveably coupled to a side wall 32 of the heat source device 10. The damper cover 52 is an arcuate or rolled plate which is slideable within a path defined between an upper track 54 and a lower track 56 (FIG. 2A). The upper track 54 is fixed about its upper portion to the side wall 32 and is positioned such that a gap is formed between the upper track 54 and the side wall 32 and the lower track 56 is fixed about is lower portion to the side wall 32 and is positioned such that a gap is formed between the lower track 56 and the side wall 32. The gaps between the tracks 54, 56 and the side wall 32 are slightly larger than the thickness of the damper cover to provide at least some freedom of movement of the damper cover 52 between the tracks 54, 56 and the side wall 32. The radius of the damper cover plate is slightly larger than that of the cylindrical side wall 32, thus allowing the damper cover 52 to move around the outer surface of the side wall 32 in a rotational sliding manner about the longitudinal axis of the chamber body 30. The upper track 54 and lower track 56 cooperate with the side wall 32 to retain the damper cover 52 alongside the side wall 32 such that the damper cover 52 is able to form an at least partially air tight seal with the side wall 32.

The side wall 32 defines a plurality of vent holes 58 spaced equidistant from one another along a circumferential arc of the side wall, the circumferential arc defined between the upper track 54 and the lower track 56. The damper cover 52 is movable by rotationally sliding the cover 52 between a fully open position (to allow a maximum flow of air through the vent holes 58 of the flue damper 24), a fully closed position (so that a majority or substantially all of the flow of air into the heat source device 10 is blocked), and a plurality of intermediate positions between the fully open and fully closed positions (such that a user can slide the damper cover to a desired position relative to the holes 58 to allow a user to adjust or maintain a desired temperature inside the heat source device 10 and the grill 12). When the damper cover 52 is positioned in the fully closed position the holes 58 are substantially covered by the damper cover 52 such that significant airflow is impeded or blocked between the exterior and interior of the device 10, preferably to a sufficient degree that combustion cannot be sustained indefinitely in the heat chamber 14 and any burning fuel will be extinguished prior to being entirely consumed. When the damper cover 52 is positioned in the fully open position, the holes 58 are substantially uncovered (i.e. the damper cover 52 is not covering the holes 58) such that significant airflow is able to flow between the exterior and the interior of the device 10. The damper cover 52 includes a handle or knob 60 to allow a user to grasp the damper cover and rotationally slide the damper cover 52 relative to the sidewall 32 and holes 58 (FIGS. 2A-4).

The grill's cooking chamber 22 includes a food cooking surface, such as a grill grate 62 (FIG. 2), for supporting a food item inside the cooking chamber 22. The food cooking surface 62 is removable or pivotable to allow a user to either remove or pivot the grill grate to allow access to a lower portion of the cooking chamber 22, if desired. The heat source device 10 allows the user to tend or maintain the heat source without (i) removing a lid 64 of the grill 12, (ii) moving the food, (iii) removing or pivoting the grill grate 62, (iv) rearranging or replacing the food along the grate 62 as needed, and (v) replacing the lid 64. The heat source device 10 allows the entire grill grate 62 to be used for cooking food, as opposed to when a fuel source is placed in a lower region of the cooking chamber 22 and pivoting portions 62a of the grill grate 62 must typically remain free of food in order to raise the pivoting portions 62a to access and maintain the fuel source.

Optionally, the heat source device 10 includes a removable and adjustable support rack for containing wood chips to be heated by the fuel source that is on the fuel grate 26, to produce smoke. As the wood chips are heated they begin to smolder and put off smoke. The smoke is directed from the heat chamber 14 through the mounting sleeve 42 and into the cooking chamber 22 of the grill 12 and the smoke adds flavor to the food items.

The ash catch pan 28 is slideably removable from the bottom of the heat source device 10 such that it may be removed and collected ashes disposed of in an appropriate manner. The ash catch pan 28 is fitted with a handle 28a to provide an external gripping location for a user to manipulate the ash catch pan 28. The ash catch pan 28 has a rear portion 28b that moves or slides along an upper surface of the device's bottom 36 to act as a scoop when the pan 28 is inserted into the heat source device 10. A front portion of the catch pan 28 forms an upright panel 28c to which the handle 28a is attached, and a horizontal panel 28d that slides under a portion of the device's bottom 36 to help prevent ash from escaping the catch pan 28. The catch pan 28 further includes a pair of upright sidewalls 28e, one of which is shown in FIG. 5, which help to contain ashes that have collected on the catch pan 28.

Inside the heat chamber 14 there is an ash deflector 66 extending upwardly from the device bottom 36, with side edges 66a that contact the interior surface of the chamber body 30, and with a curved top edge 66b that contacts or lies in close proximity to the chamber body just below the vent holes 58. The ash deflector 66 prevents ash from collecting along a periphery of the bottom 36 below the vent holes 58, which is not covered by the catch pan 28. Thus, most ash falling in the vicinity of the ash deflector 66 will be directed toward the catch pan 28 between the upright sidewalls 28e, for subsequent removal. It will be appreciated that another ash deflector may be placed along an opposite side of the heat chamber 14 for substantially the same purpose, regardless of whether or not there is a set of vent holes 58 in that region of the chamber body 30. The catch pan sidewalls 28e are positioned just inboard of the respective ash deflectors 66 when the catch pan 28 is installed.

Optionally, the water pan 29 is disposed in the grill's cooking chamber, or a smaller version may be provided in the heat chamber 14, to increase the relative moisture inside the cooking chamber 22. The water pan may be positioned within the heat chamber 14 such that it blocks direct heat from the heat chamber 14 transferring to the food, thereby providing indirect heat to cook the food without cooking the exterior of the food item too quickly. The additional moisture from the water pan may decrease the amount of surface dehydration experienced by the food being cooked, thereby maintaining a higher moisture content and better flavor of the finished food product. The water pan may be removable from the heat source device 10 such that it may be removed and more water can be added after it has evaporated.

Optionally, the heat source device 10, when coupled to cooking grill 12, can be utilized as an ash catcher, such as when the heat source used for cooking is located inside the cooking chamber 20 of the grill 12. As such, ash produced as the heat source burns can fall downward through the ash disposal port on the lower portion of the grill body 44, through the heat transfer opening 40, and into the chamber body 30, such as into the ash catch pan 28.

Accordingly, the heat source device of the present invention provides a feedable heat source for a grill that allows a grill to operate and cook substantially uninterrupted for an indefinite time so long as the fuel source is maintained in the heat source device. The heat source device provides a heat chamber body that includes an access door that allows a user to access the heat source in order to tend and maintain the heat source by adding or removing fuel from the heat source. The heat source device includes a mounting adapter to releasably couple the device to a pre-manufactured grill to retrofit the grill. The mounting device may be configured to couple to a portion of an existing ash catcher originally provided on the grill, such as a mounting sleeve for the grill's original ash catcher. The heat source device includes a flue damper to adjust the flow of air into the heat chamber and regulate the consumption rate of the fuel in the heat chamber. The heat source device supplies indirect heat to the cooking chamber of the grill, such that the temperature of the cooking chamber is substantially consistent throughout the cooking chamber. The consistent temperature reduces the risk of cooking one portion of the food item(s) too quickly, and of slowing the cooking process or undercooking the food due to cool-off periods caused by removing the grill lid. The heat source device may also supply smoke to the cooking chamber to smoke the food items during the cooking process. The heat source device may be incorporated into a new production grill, or may be configured as a retrofit for existing grills with bottom vents for air and/or ashes.

Changes and modifications in the specifically described embodiments can be carried out without departing from the principles of the present invention, which is intended to be limited only by the scope of the appended claims, as interpreted according to the principles of patent law, including the doctrine of equivalents.

The embodiments of the invention in which an exclusive property is claimed are defined as follows:

1. A smoke and heat source device for a cooking grill, said device comprising:
a heat chamber configured to contain a heat source, said heat chamber having a sidewall and an upper region defining an upwardly-facing top opening, said upper region configured to releasably couple to an exterior of a cooking grill proximate a lower aperture formed in an exterior lower portion of the cooking grill; and
an access door operably disposed along said sidewall of said heat chamber, said access door configured to provide selective access to an interior of said heat chamber;
wherein said device is operable to direct heat and smoke through said top opening and the lower aperture to the cooking chamber of the grill.

2. The smoke and heat source device of claim 1, further in combination with the cooking grill, wherein the cooking chamber of said cooking grill is configured to support a food item to be cooked, said cooking grill adapted for low temperature cooking or smoking of food.

3. The smoke and heat source device and cooking grill of claim 2, further comprising:
a mounting adapter configured to mount said device to a portion of said cooking grill proximate said lower aperture; and
a heat transfer aperture in an upper portion of said heat chamber, said heat transfer aperture configured to allow the heat and smoke to transfer through the lower aperture in the cooking chamber portion of said cooking grill.

4. The smoke and heat source device and cooking grill of claim 3, wherein said mounting adapter comprises a handle portion and a mounting tab disposed on an upper portion of said sidewall and configured to releaseably and selectively engage a mounting sleeve which is coupled to said exterior lower portion of said cooking grill.

5. The smoke and heat source device and cooking grill of claim 4, wherein said handle portion and said mounting tab are spaced apart from one another and positioned in spaced arrangement along an exterior of said sidewall.

6. The smoke and heat source device and cooking grill of claim 5, wherein said handle portion and said mounting tab are positioned to align with respective receiver slots formed in said mounting sleeve, such that said handle portion and said mounting tab are insertable and rotatably engageable with respective ones of said receiver slots, wherein said device is supported by said mounting sleeve when said handle portion and said mounting tab are fully engaged with said mounting sleeve.

7. A heat source device for supplying heat to a cooking grill, said heat source device comprising:
a heat chamber body that defines a heat chamber, said chamber body configured to be spaced apart from a cooking chamber of the grill and configured to support a combustible fuel heat source;
an access door operably coupled to said heat chamber body, said access door configured to provide access to the heat source inside said heat chamber;
a mounting adapter configured to couple said heat source device to the cooking chamber of the grill; and
a heat transfer aperture in an upper portion of said heat chamber body, said heat transfer aperture configured to direct heat and smoke to rise upward through an aperture in a lower portion of the cooking chamber portion of the grill;
wherein said heat source device is configured to allow a user to maintain and regulate the heat source without opening the cooking chamber of the cooking grill.

8. The heat source device of claim 7, wherein said mounting adapter comprises a handle portion and a mounting tab disposed on an upper portion of said chamber body, said mounting adapter configured to selectively releaseably engage a mounting sleeve that is coupled to a lower portion of the cooking chamber portion of the grill.

9. The heat source device of claim 8, wherein said handle portion and said mounting tab are spaced apart from one another and positioned in spaced arrangement along an exterior of said chamber body.

10. The heat source device of claim 9, wherein said handle portion and said mounting tab are positioned to align with respective receiver slots formed in the mounting sleeve, wherein said handle portion and said mounting tab are insertable and rotatably engageable with respective ones of said receiver slots, wherein said heat source device is supportable by the mounting sleeve when said handle portion and said mounting tab are fully engaged with the mounting sleeve.

11. The heat source device of claim 7, further comprising a flue damper disposed on a portion of said heat chamber body and operable to regulate the amount of air flow into said heat chamber.

12. The heat source device of claim 7, further comprising a fuel support rack removably disposed inside of said heat chamber body.

13. The heat source device of claim 7, further comprising an ash catch pan removably inserted into said heat chamber of said heat chamber body.

14. A heat source device for supplying heat to a cooking grill, said heat source device comprising:
a heat chamber body that defines a heat chamber, said chamber body configured to be spaced apart from a cooking chamber of the grill and configured to confine a combustible fuel heat source;
an access door operably coupled to a sidewall of said heat chamber body, said access door configured to provide access to the heat source inside said heat chamber;
a mounting adapter configured to releasably mount said heat source device to an ash catcher mount along a lower portion of the cooking grill; and
a heat transfer aperture in an upper portion of said heat chamber body, said heat transfer aperture configured to allow heat and smoke to rise upward through an aperture in the lower portion of the grill;
wherein said heat source device is configured to allow a user to maintain and regulate the heat source without opening the cooking chamber of the cooking grill.

15. The heat source device of claim 14, wherein said mounting adapter comprises a handle portion and a mounting tab disposed on an upper portion of said heat chamber body and configured to selectively releaseably engage the ash catcher mount.

16. The heat source device of claim 15, wherein said handle portion and said mounting tab are spaced apart from one another and positioned in spaced arrangement along an exterior of said heat chamber body.

17. The heat source device of claim 16, wherein said handle portion and said mounting tab are positioned to align with respective receiver slots formed in the ash catcher mount, such that said handle portion and said mounting tab are insertable and rotatably engageable with the respective receiver slots, wherein said heat source device is supported by the ash catcher mount when said handle portion and said mounting tab are fully engaged with the ash catcher mount.

18. The heat source device of claim 14, further comprising a flue damper disposed along said heat chamber body, said flue damper operable to regulate the amount of air flow into said heat chamber.

19. The heat source device of claim 14, further comprising a fuel support rack removably disposed inside of said heat chamber body.

20. The heat source device of claim 14, further comprising an ash catch pan removably inserted into said heat chamber of said heat chamber body.
